(19) United States
(12) Patent Application Publication
(10) Pub. No.: US 2020/0387919 A1
(43) Pub. Date: Dec. 10, 2020

(54) PRODUCT EVALUATION BASED ON DYNAMIC METRICS

(71) Applicant: International Business Machines Corporation, Armonk, NY (US)

(72) Inventors: Lucas Palhares Piva, Vinhedo (BR); Sergio Varga, Campinas (BR); Flavio Rangel Remunini, São Paulo (BR); Patricia Cortizo de Argolo Nobre, Campinas (BR)

(21) Appl. No.: 16/435,650

(22) Filed: Jun. 10, 2019

(51) Int. Cl. G06Q 30/02; G06F 16/9537; G06N 20/00

(52) U.S. Cl. CPC G06Q 30/0206; G06N 20/00; G06F 16/9537

(57) ABSTRACT

An approach is provided in which an information handling system identifies a set of metrics corresponding to a product in response to receiving an initial set of product data corresponding to the product. Next, the information handling system captures an additional set of product data in response to determining that the additional set of product data is required based on the set of metrics. The information handling system computes a market value of the product based, at least in part, on the set of metrics, the set of product data, and the additional set of product data. In turn, the information handling system provides the market value to a user.

### BACKGROUND

The digital economy has helped to create a very individualistic and independent society. Electronic commerce, or ecommerce, has become a standard form of exchanging goods over the years due to advances in security and the amount of merchants that sell goods over the Internet. In addition, bandwidth technology has heightened a user's online experience because the user can effortlessly browse several different ecommerce sites, watch video reviews, view product pictures, and eventually decide on a product to purchase. As a result, users typically prefer to buy products online instead of traveling to brick and mortar stores because the online experience is more productive, more convenient, and more competitive.

Individual consumers also use ecommerce to sell their goods, both new and used. The rapid growth of smartphones allows users to easily take pictures of a used product and post their product on an ecommerce site specifically targeted for selling used products. Buying and selling used products comes with a host of issues not typically seen with buying and selling new products, such as the product's condition and a fair selling price of the used product, which is typically based on several criteria.

The market for used goods is a multi-billion market, and many tools are available to sell the used goods. One important activity to sell the used goods is to evaluate the goods and derive a fair selling price. Unfortunately, this activity is performed by an individual that is not a professional. For a buyer it can give an uncertainty since he/she cannot be sure the good is in a good health or within a valid price range. For sellers it can be a missed opportunity since he/she could not sell the good because it was not properly evaluated and priced. As a result, millions of selling opportunities are lost because of the lack of proper evaluation and pricing of a product.

### BRIEF SUMMARY

According to one embodiment of the present disclosure, an approach is provided in which an information handling system identifies a set of metrics corresponding to a product in response to receiving an initial set of product data corresponding to the product. Next, the information handling system captures an additional set of product data in response to determining that the additional set of product data is required based on the set of metrics. The information handling system computes a market value of the product based, at least in part, on the set of metrics, the set of product data, and the additional set of product data. In turn, the information handling system provides the market value to a user.

The foregoing is a summary and thus contains, by necessity, simplifications, generalizations, and omissions of detail; consequently, those skilled in the art will appreciate that the summary is illustrative only and is not intended to be in any way limiting. Other aspects, inventive features, and advantages of the present disclosure, as defined solely by the claims, will become apparent in the non-limiting detailed description set forth below.

According to an aspect of the present invention there is a method, system and/or computer program product that performs the following operations (not necessarily in the following order): (i) identifying a set of metrics corresponding to a product in response to receiving an initial set of product data corresponding to the product; (ii) capturing an additional set of product data in response to determining that the additional set of product data is required based on the set of metrics; (iii) computing a market value of the product based, at least in part, on the set of metrics, the set of product data, and the additional set of product data; and (iv) providing the market value to a user.

### BRIEF DESCRIPTION OF THE SEVERAL VIEWS OF THE DRAWINGS

The present disclosure may be better understood, and its numerous objects, features, and advantages made apparent to those skilled in the art by referencing the accompanying drawings, wherein:

FIG. 1 is a block diagram of a data processing system in which the methods described herein can be implemented;

FIG. 2 provides an extension of the information handling system environment shown in FIG. 1 to illustrate that the methods described herein can be performed on a wide variety of information handling systems which operate in a networked environment;

FIG. 3 is an exemplary diagram depicting a dynamic product analysis system evaluating a product and providing a buyer and seller with relevant product information;

FIG. 4 is an exemplary flowchart showing steps taken to evaluate and price a product;

FIG. 5 is an exemplary diagram depicting stages of assessing a product's metrics;

FIG. 6 is an exemplary flowchart showing steps taken to train a dynamic product analysis system's machine learning engine;

FIG. 7 is an exemplary diagram showing a vehicle with attached Internet of Things (IoT) devices that capture relevant product information for use by a dynamic product analysis system; and

FIG. 8 is an exemplary diagram showing an appliance with attached Internet of Things (IoT) devices that capture relevant product information for use by a dynamic product analysis system.

### DETAILED DESCRIPTION

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The embodiment was chosen and described in order to best explain the principles of the disclosure and the practical application, and to enable others of ordinary skill in the art to understand the disclosure for various embodiments with various modifications as are suited to the particular use contemplated.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions. The following detailed description will generally follow the summary of the disclosure, as set forth above, further explaining and expanding the definitions of the various aspects and embodiments of the disclosure as necessary.

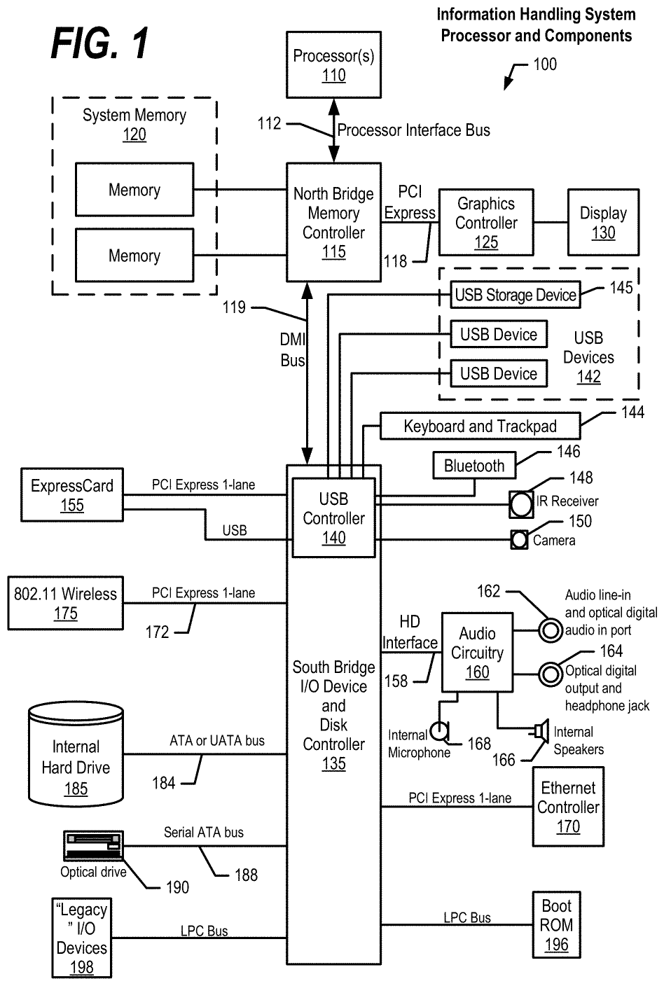

FIG. 1 illustrates information handling system 100, which is a simplified example of a computer system capable of performing the computing operations described herein. Information handling system 100 includes one or more processors 110 coupled to processor interface bus 112. Processor interface bus 112 connects processors 110 to Northbridge 115, which is also known as the Memory Controller Hub (MCH). Northbridge 115 connects to system memory 120 and provides a means for processor(s) 110 to access the system memory. Graphics controller 125 also connects to Northbridge 115. In one embodiment, Peripheral Component Interconnect (PCI) Express bus 118 connects Northbridge 115 to graphics controller 125. Graphics controller 125 connects to display device 130, such as a computer monitor.

Northbridge 115 and Southbridge 135 connect to each other using bus 119. In some embodiments, the bus is a Direct Media Interface (DMI) bus that transfers data at high speeds in each direction between Northbridge 115 and Southbridge 135. In some embodiments, a PCI bus connects the Northbridge and the Southbridge. Southbridge 135, also known as the Input/Output (I/O) Controller Hub (ICH) is a chip that generally implements capabilities that operate at slower speeds than the capabilities provided by the Northbridge. Southbridge 135 typically provides various busses used to connect various components. These busses include, for example, PCI and PCI Express busses, an ISA bus, a System Management Bus (SMBus or SMB), and/or a Low Pin Count (LPC) bus. The LPC bus often connects low-bandwidth devices, such as boot ROM 196 and “legacy” I/O devices (using a “super I/O” chip). The “legacy” I/O devices (198) can include, for example, serial and parallel ports, keyboard, mouse, and/or a floppy disk controller. Other components often included in Southbridge 135 include a Direct Memory Access (DMA) controller, a Programmable Interrupt Controller (PIC), and a storage device controller, which connects Southbridge 135 to nonvolatile storage device 185, such as a hard disk drive, using bus 184.

ExpressCard 155 is a slot that connects hot-pluggable devices to the information handling system. ExpressCard 155 supports both PCI Express and Universal Serial Bus (USB) connectivity as it connects to Southbridge 135 using both the USB and the PCI Express bus. Southbridge 135 includes USB Controller 140 that provides USB connectivity to devices that connect to the USB. These devices include webcam (camera) 150, infrared (IR) receiver 148, keyboard and trackpad 144, and Bluetooth device 146, which provides for wireless personal area networks (PANs). USB Controller 140 also provides USB connectivity to other miscellaneous USB connected devices 142, such as a mouse, removable nonvolatile storage device 145, modems, network cards, Integrated Services Digital Network (ISDN) connectors, fax, printers, USB hubs, and many other types of USB connected devices. While removable nonvolatile storage device 145 is shown as a USB-connected device, removable nonvolatile storage device 145 could be connected using a different interface, such as a Firewire interface, etcetera.

Wireless Local Area Network (LAN) device 175 connects to Southbridge 135 via the PCI or PCI Express bus 172. LAN device 175 typically implements one of the Institute of Electrical and Electronic Engineers (IEEE) 802.11 standards of over-the-air modulation techniques that all use the same protocol to wireless communicate between information handling system 100 and another computer system or device. Optical storage device 190 connects to Southbridge 135 using Serial Analog Telephone Adapter (ATA) (SATA) bus 188. Serial ATA adapters and devices communicate over a high-speed serial link. The Serial ATA bus also connects Southbridge 135 to other forms of storage devices, such as hard disk drives. Audio circuitry 160, such as a sound card, connects to Southbridge 135 via bus 158. Audio circuitry 160 also provides functionality associated with audio hardware such as audio line-in and optical digital audio in port 162, optical digital output and headphone jack 164, internal speakers 166, and internal microphone 168. Ethernet controller 170 connects to Southbridge 135 using a bus, such as the PCI or PCI Express bus. Ethernet controller 170 connects information handling system 100 to a computer network, such as a Local Area Network (LAN), the Internet, and other public and private computer networks.

While FIG. 1 shows one information handling system, an information handling system may take many forms. For example, an information handling system may take the form of a desktop, server, portable, laptop, notebook, or other form factor computer or data processing system. In addition, an information handling system may take other form factors such as a personal digital assistant (PDA), a gaming device, Automated Teller Machine (ATM), a portable telephone device, a communication device or other devices that include a processor and memory.

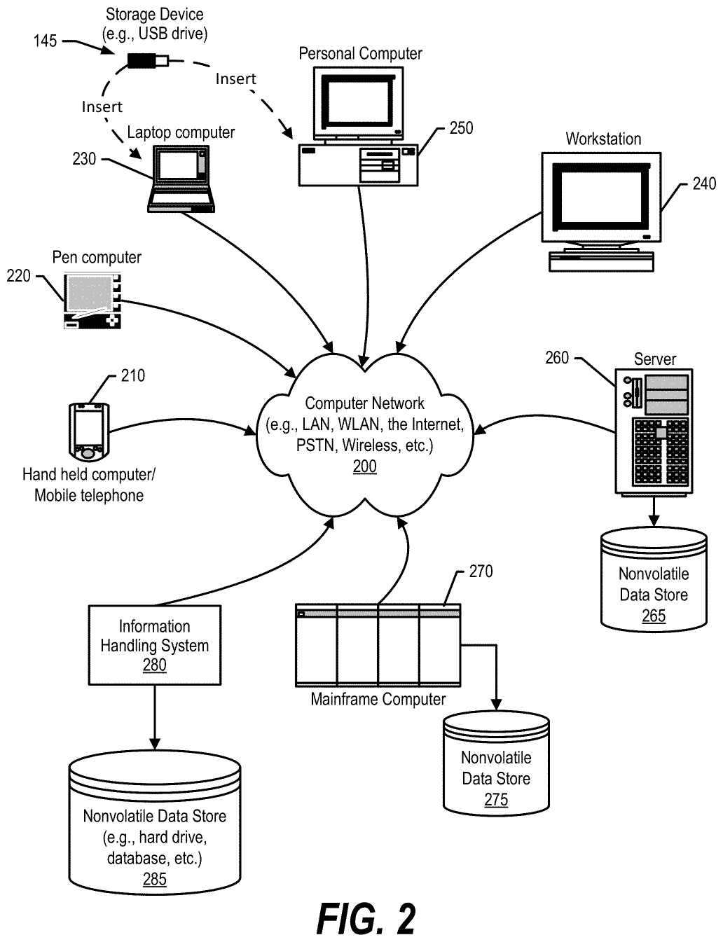

FIG. 2 provides an extension of the information handling system environment shown in FIG. 1 to illustrate that the methods described herein can be performed on a wide variety of information handling systems that operate in a networked environment. Types of information handling systems range from small handheld devices, such as handheld computer/mobile telephone 210 to large mainframe systems, such as mainframe computer 270. Examples of handheld computer 210 include personal digital assistants (PDAs), personal entertainment devices, such as Moving Picture Experts Group Layer-3 Audio (MP3) players, portable televisions, and compact disc players. Other examples of information handling systems include pen, or tablet, computer 220, laptop, or notebook, computer 230, workstation 240, personal computer system 250, and server 260. Other types of information handling systems that are not individually shown in FIG. 2 are represented by information handling system 280. As shown, the various information handling systems can be networked together using computer network 200. Types of computer network that can be used to interconnect the various information handling systems include Local Area Networks (LANs), Wireless Local Area Networks (WLANs), the Internet, the Public Switched Telephone Network (PSTN), other wireless networks, and any other network topology that can be used to interconnect the information handling systems. Many of the information handling systems include nonvolatile data stores, such as hard drives and/or nonvolatile memory. The embodiment of the information handling system shown in FIG. 2 includes separate nonvolatile data stores (more specifically, server 260 utilizes nonvolatile data store 265, mainframe computer 270 utilizes nonvolatile data store 275, and information handling system 280 utilizes nonvolatile data store 285). The nonvolatile data store can be a component that is external to the various information handling systems or can be internal to one of the information handling systems. In addition, removable nonvolatile storage device 145 can be shared among two or more information handling systems using various techniques, such as connecting the removable nonvolatile storage device 145 to a USB port or other connector of the information handling systems.

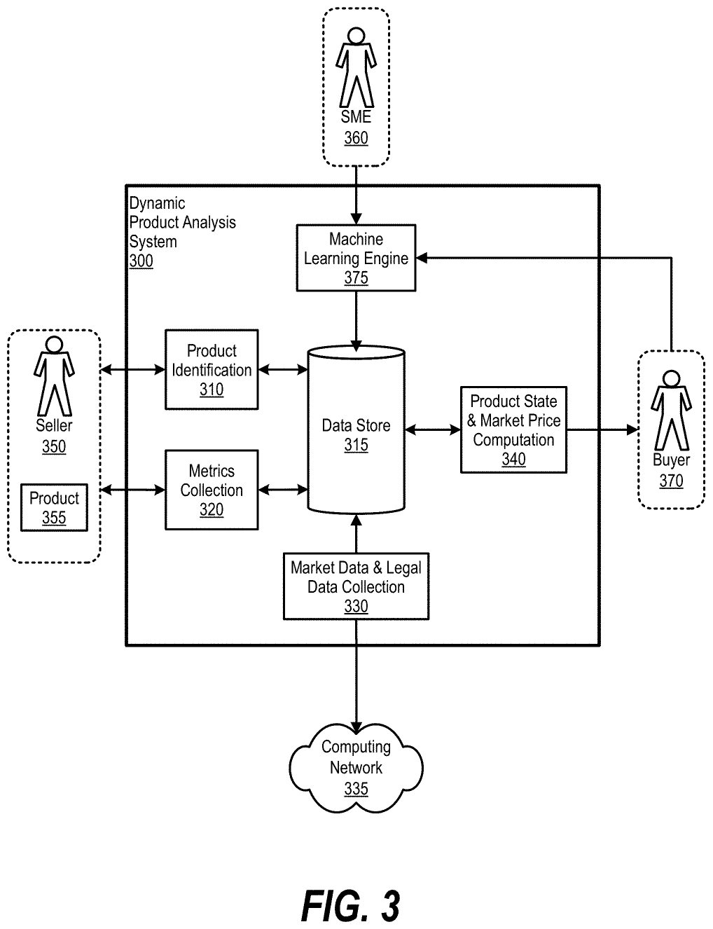

FIGS. 3 through 7 depict an approach that can be executed on an information handling system that evaluates products by leveraging a metrics and evaluation criteria knowledge base that is powered by machine learning and artificial intelligence (AI). The information handling system evaluates factors such as depreciation, market value, internal physical product characteristics, and external physical product characteristics to determine a fair market price of the product. With a set of predefined metrics evaluation, the information handling system evaluates a product while leveraging its condition, age, market value, and other important metrics that are specific to the product. The information handling system identifies the product, collects metrics values using AI techniques and technology, and calculates an accurate value price based on the intuitive evaluation.

FIG. 3 is an exemplary diagram depicting a dynamic product analysis system evaluating a product and providing a buyer and seller with relevant product information. Seller 350 uses dynamic product analysis system 300 to evaluate product 355 and eventually provide a viable selling market price to buyer 370. In one embodiment, as discussed herein, buyer 370 uses dynamic product analysis system 300 to derive a fair price of a product that buyer 370 wishes to purchase.

Dynamic product analysis system 300, in one embodiment, is a cloud-based service environment that is accessible through electronic devices such as a smartphone, tablet, and etcetera. Dynamic product analysis system 300 includes several modules, which may be software modules, hardware modules, or a combination of hardware and software.

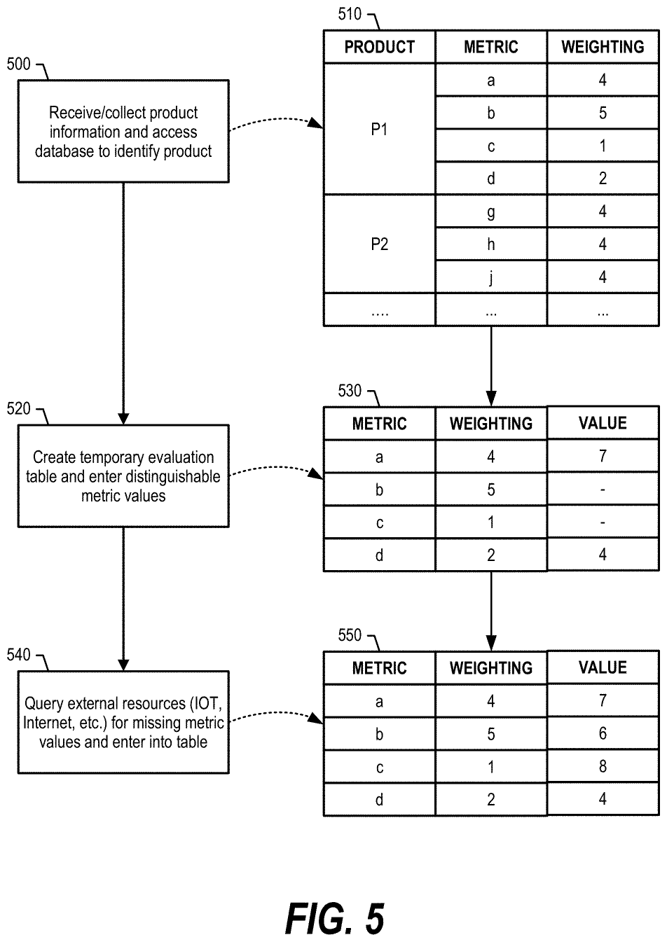

Dynamic product analysis system 300 includes product identification 310, which interacts with seller 350 and collects product information regarding product 355 and stores the information in data store 315 (see FIG. 5 and corresponding text for further details). Product identification 310 captures detailed information about product 355 by accessing external and non-structured media while identifying additional metrics needed to evaluate product 355 (e.g., make/model of vehicle). In one embodiment, subject matter expert (SME) 360 provides an initial set of information to machine learning engine 375, which stores relevant metrics for products in data store 315 (e.g., make/model of vehicle, year, mileage, etc.).

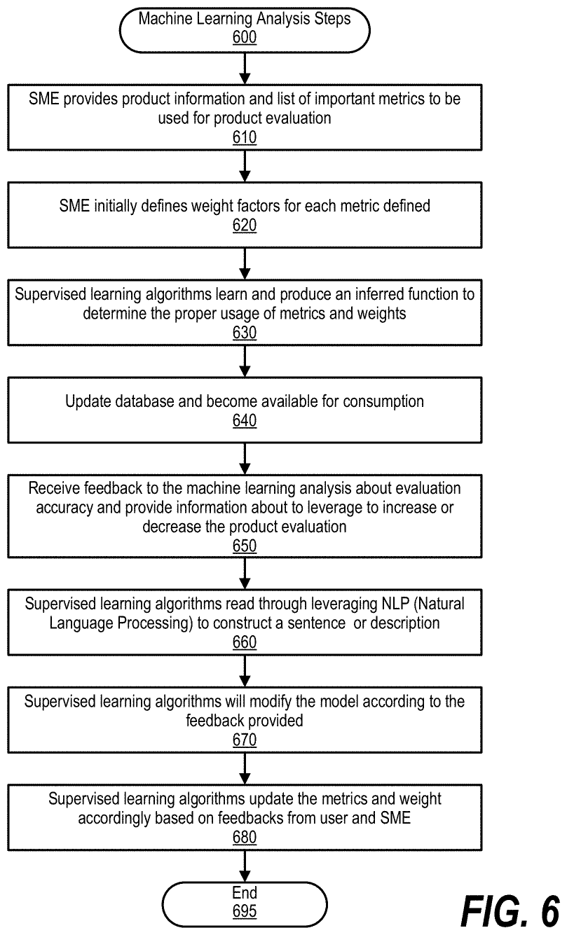

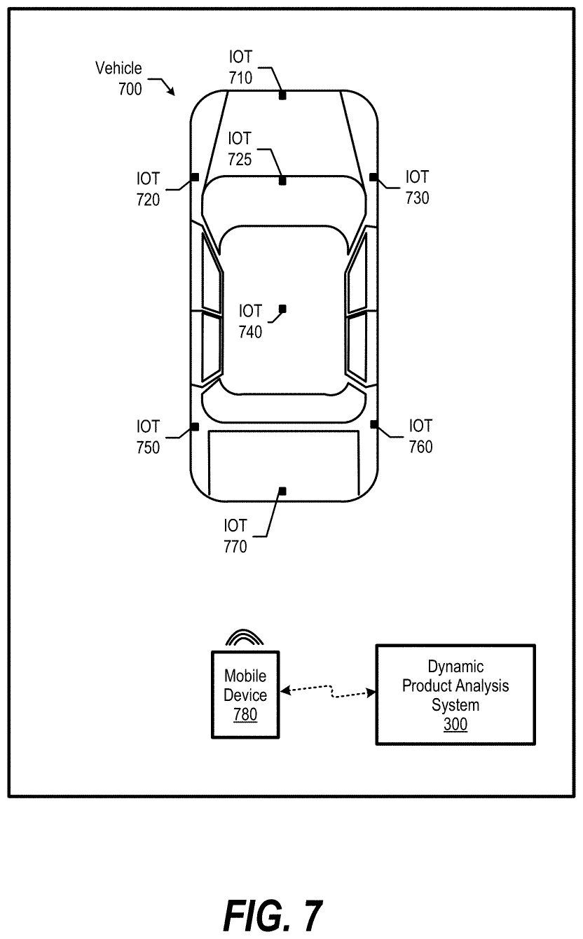

Dynamic product analysis system 300 includes metrics collection 320, which captures information based on the identified metrics via product identification 310 (e.g., condition of tires) and stores them in data store 315 (see FIG. 5 and corresponding text for further details). Metrics collection 320 also collects additional metrics from seller 350 using different Al and IOT technologies (see FIGS. 6, 7, and corresponding text for further details).

Market data and legal data collection 330 collects market values and legal product information related to the product via computer network 335 (e.g., the Internet), such as current selling prices, recalls, time on the market, and etcetera. The information is stored in data store 315.

Product state and market price computation 340 evaluates and calculate the market price of the product while leveraging the product's metrics and evaluation database built by SME 360. Product state and market price computation 340 provides the calculated market price to buyer 370. Machine learning engine 375 receives feedback from buyer 370 (e.g., priced too high, short time on the market indicating priced too low, need information on a specific metric, etc.) and retrains machine learning engine 375, which properly updates metrics store 315 by adding additional metrics or removing metrics or adding new products. As a result, dynamic product analysis system 300 maintains up-to-date metrics based on market demands.

In one embodiment, buyer 370 uses dynamic product analysis system 300 to identify and evaluate a product buyer 370 wish to purchase. In this embodiment, dynamic product analysis system 300 receives a picture of a product (e.g., microwave oven) that buyer 370 wants to purchase. By the picture analysis, dynamic product analysis system 300 captures information about the product, such as the model number, and searches computer network 335 to collect more details about the product (size, retail price, etc.). Dynamic product analysis system 300, in one embodiment, uses artificial intelligence technologies that handle non-structured data (text, pictures, audio) to identify the product. Once dynamic product analysis system 300 properly identifies which product buyer 370 is willing to buy, dynamic product analysis system 300 updates the product information in data store 315.

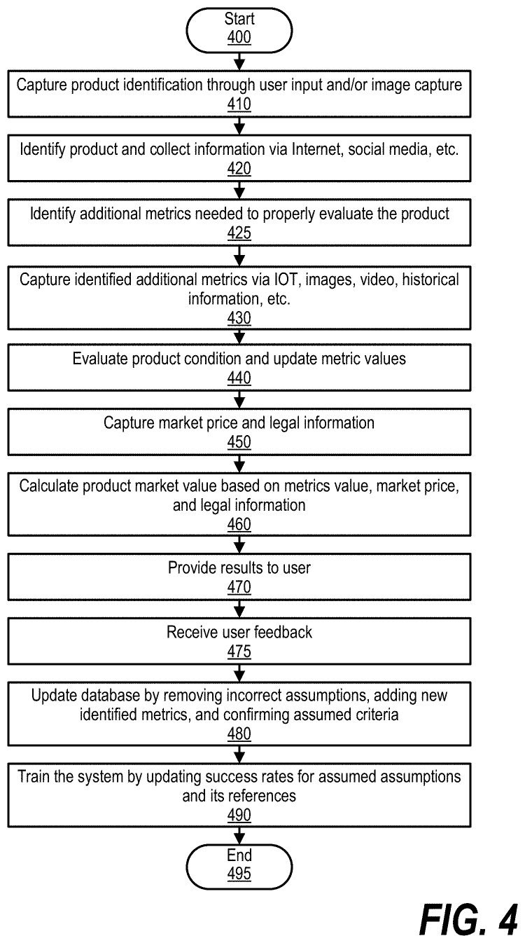

Next, dynamic product analysis system 300 verifies which additional metrics are needed (or important) to properly evaluate the product. Dynamic product analysis system 300 retrieves the information from data store 315, which is a corpus database built using machine learning technology and includes information about products, which metrics are required (and optional) to properly evaluate a product. Data store 315 also contains an index criterion that dynamic product analysis system 300 uses during calculations (see FIG. 4 and corresponding text for further details). Based on the state of each metric, dynamic product analysis system 300 weighs the metrics and provides value parameters for calculation.

Dynamic product analysis system 300 then captures the additional metrics identified for the product via, for example, metrics collection 320. The metrics capture leverages technology such as IOT (sensors deployed from inside the products, or temporary used by the user), images or videos, product historical usage (from built-in product processors). Buyer 370 uses the temporary sensors to measure information such as, for example, the time the oven takes to get to a maximum temperature, radiation levels, etc. Using AI technologies and machine learning technology, dynamic product analysis system 300 evaluates the product condition and updates the value of the corresponding metrics.

Dynamic product analysis system 300 then collects additional information not related to product condition such as market value and any legal record or health recommended information (e.g., product recalls). Besides the sensors information to verify the microwave oven's real conditions, dynamic product analysis system 300 compares the microwave oven to other microwave ovens of the same model to check the market value. Dynamic product analysis system 300 then calculates the product value based on metrics collected and database evaluation criteria. In the case of the microwave oven, the metrics such as time the oven requires to reach a maximum temperature and measured radiation levels are considered along with the market values to define the product pricing. Dynamic product analysis system 300 provides buyer 370 the projected product value based on the information collected.

Then, dynamic product analysis system 300 collects pricing feedback provided by buyer 370 to feed into machine learning engine 375, such as the accuracy of result and/or additional information requested that was not initially identified. Dynamic product analysis system 300 updates data store 315 based on buyer 370's feedback with the support of SME 360 for more accurate future evaluations.

In one embodiment, dynamic product analysis system 300 is an objective, self-contained, and independent third-party intermediary. In this embodiment, dynamic product analysis system 300 captures pictures of product 355 via IoT devices and proceeds through steps discussed herein to perform visual recognition of the product and compute an accurate market value price. Dynamic product analysis system 300 sends the market value (market price) to buyer 370 and waits for buyer 370's response. In this embodiment, dynamic product analysis system 300 prohibits seller 350 from altering the selling price, which gives buyer 370 the confidence the selling price is a fair price for product 355.

FIG. 4 is an exemplary flowchart showing steps taken to evaluate and price a product. FIG. 4 processing commences at 400 whereupon, at step 410, the process captures product information through user input and/or image capture mechanisms. At step 420, the process identifies the product (e.g., model number) and collects information about the identified via the Internet, social media, etc.

At step 425, the process identifies additional metrics needed to properly evaluate the product, such as age, features, etc. At step 430, the process captures the identified additional metrics via IOT devices, images, video, historical information, etc. At step 440, the process evaluates the product condition based on the collected information and updates the metric values (see FIG. 5 and corresponding text for further details).

At step 450, the process captures market price and legal information and, at step 460, the process calculates a product market value based on the metrics value, market price, and legal information. At step 470, the process provides the results to the user (e.g., a buyer). At step 475, the process receives user feedback and, at step 480, the process updates the database by removing incorrect assumptions, adding new identified metrics, and confirming assumed criteria. At step 490, the process trains the system by updating success rates of the assumed assumptions and its references. FIG. 4 processing thereafter ends at 495.

FIG. 5 is an exemplary diagram depicting stages of collecting and assessing a product's metrics. At stage 500, dynamic product analysis system 300 receives and collects product information and accesses data store 315 to identify the product. In one embodiment, table 510 is populated with products, metrics, and weightings based on initial information received from SME 360.

Once dynamic product analysis system 300 identifies the product, such as its model number, dynamic product analysis system 300 creates table 530 (stage 520) that includes metrics/weightings relative to the product under evaluation. Dynamic product analysis system 300 also adds identified values corresponding to certain values. For example, dynamic product analysis system 300 may identify the mileage of a vehicle and enter a value into a vehicle mileage metric (e.g., higher value for lower mileage).

Next, dynamic product analysis system 300 queries external resources for missing metric values and enters the values into the table (table 550). For example, dynamic product analysis system 300 may query an IoT device inside a vehicle for the condition of the seats. At this point dynamic product analysis system 300 determines a price for the product and provides the product to buyer 370 based on the values entered in table 550. As discussed herein, dynamic product analysis system 300 may receive feedback from buyer 370 and add additional metrics to the table for subsequent evaluations (e.g., trim package type).

FIG. 6 is an exemplary flowchart showing steps taken to train dynamic product analysis system 300's machine learning engine 375. FIG. 6 processing commences at 600 whereupon, at step 610, SME 360 provides product information and a list of important metrics to be used for product evaluation. At step 620, the process receives initially defined weighting factors from SME 360 for each metric defined. At step 630, supervised learning algorithms learn and produce an inferred function to determine the proper usage of the metrics and weightings. At step 640, the process updates a product database in data store 315 that becomes available for consumption.

At step 650, in response to dynamic product analysis system 300 providing product pricing to buyer 370, the process receives feedback and applies the feedback to the machine learning engine. At step 660, the supervised machine learning algorithms read through the feedback using NLP (Natural Language Processing) to construct a sentence or description. At step 670, the supervised learning algorithms modify the machine learning model according to the feedback provided.

At step 680, the supervised learning algorithms update the metrics and weightings accordingly based on the modified machine learning engine. FIG. 6 processing thereafter ends at 695.

FIG. 7 is an exemplary diagram showing a vehicle that includes Internet of Things (IoT) devices that capture relevant product information for use by dynamic product analysis system 300. In one embodiment, IoTs 710 through 770 are attached to vehicle 700 by the vehicle manufacturer. In another embodiment, a seller of vehicle 700 attaches IoTs 710 through 770 to vehicle 700 to accurately capture visual data. (e.g., certifiable data).

When a user plans to buy or sell a vehicle, the user provides input values, such as product name, version, and manufacturing data to dynamic product analysis system 300, such as by using a user interface or app on mobile device 780. For example, the user inputs the car name, the version, and build year.

Dynamic product analysis system 300 then uses IoT 710, 720, 725, 730, 740, 750, 760, and 770 to capture visual information around the car. In one embodiment, dynamic product analysis system 300 interfaces to the IoTs through mobile device 780 to collect information pertaining to the condition of vehicle 700. For example, IoTs 720, 730, 750, and 760 capture tread wear of each tire. The sensors scan results are transferred from the IoT's to dynamic product analysis system 300 directly or through mobile device 780.

Dynamic product analysis system 300 then executes a second request to the user and/or request possible new parameters to be scanned for vehicle 700, such as verifying a degradation of a visual part of vehicle that could cause upcoming expense (e.g., cracked windshield).

Dynamic product analysis system 300 then searches the Internet, for example, for more references of the vehicle, such as market pricing, legal details (e.g., accidents, stolen, etc.). Based on the collected information, dynamic product analysis system 300 defines a fair price for vehicle 700. The mathematic calculation occurs according to each type of finding defined on the scan. Dynamic product analysis system 300 provides the final costs results of the car and the value is adjusted in a current monetary form (e.g., buyer 370's country) for the user with the evaluation analysis.

Dynamic product analysis system 300 receives feedback from buyer 370 and uses machine learning to improve the output results for future users. In addition, based on the user feedback, dynamic product analysis system 300 removes incorrect assumptions or incorporates new metrics into data store 315.

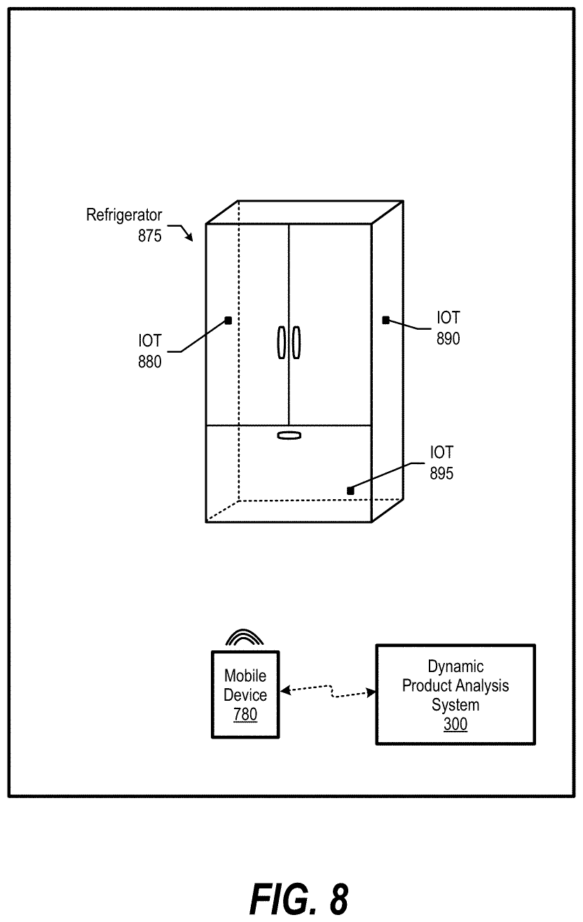

FIG. 8 is an exemplary diagram showing an appliance with attached Internet of Things (IoT) devices that capture relevant product information for use by dynamic product analysis system 300. When seller 350 intends to sell an appliance such as a refrigerator 875, dynamic product analysis system 300 receives from seller 350 a picture of the refrigerator and analyzes the picture. As discussed above, seller 350 may use an interface or app on mobile device 780 to communicate with dynamic product analysis system 300.

Dynamic product analysis system 300 identifies the model and captures more information by searching computer network 335 (e.g., the Internet and social media sites.). In one embodiment, dynamic product analysis system 300 uses artificial intelligence technologies that handle non-structured data (text, pictures, audio). Once dynamic product analysis system 300 properly identifies which product seller 350 is willing to sell, dynamic product analysis system 300 updates the product information in data store 315.

Next, based on the detail product identification, dynamic product analysis system 300 determines additional metrics that are required to properly evaluate the product, such as the amount of hours on refrigerator 875's compressor. Dynamic product analysis system 300 then captures the additional metrics identified for the refrigerator. In one embodiment, dynamic product analysis system 300 leverages technologies such as IOT sensors deployed from inside the product or temporary used by the user, images or videos, and/or product historical usage (from built-in product processors). In one embodiment, the refrigerator manufacturer installs IoTs 880 and 890 to measure the maximum/minimum temperatures, and installs IoT 895 to measure compressor hours, engine noise, and/or general electrical information.

Using AI technologies and machine learning technology, dynamic product analysis system 300 evaluates the product condition and updates the values of the metrics. Dynamic product analysis system 300, in one embodiment, collects additional information not related to product condition such as market value and any legal record or health recommended information using AI technology and accessing the Internet or social media. Dynamic product analysis system 300 compares refrigerator 875 to other refrigerators of the same model (or different model) to check the market value.

Then, dynamic product analysis system 300 updates the identified metrics based on the information collected and updates the product information accordingly. In turn, dynamic product analysis system 300 calculates the product value accordingly and provides the product value to buyer 370. Dynamic product analysis system 300 receives feedback from buyer 370 and/or seller 350 that dynamic product analysis system 300 uses to further train its machine learning engine.

While particular embodiments of the present disclosure have been shown and described, it will be obvious to those skilled in the art that, based upon the teachings herein, that changes and modifications may be made without departing from this disclosure and its broader aspects. Therefore, the appended claims are to encompass within their scope all such changes and modifications as are within the true spirit and scope of this disclosure. Furthermore, it is to be understood that the disclosure is solely defined by the appended claims. It will be understood by those with skill in the art that if a specific number of an introduced claim element is intended, such intent will be explicitly recited in the claim, and in the absence of such recitation no such limitation is present. For non-limiting example, as an aid to understanding, the following appended claims contain usage of the introductory phrases “at least one” and “one or more” to introduce claim elements. However, the use of such phrases should not be construed to imply that the introduction of a claim element by the indefinite articles “a” or “an” limits any particular claim containing such introduced claim element to disclosures containing only one such element, even when the same claim includes the introductory phrases “one or more” or “at least one” and indefinite articles such as “a” or “an”; the same holds true for the use in the claims of definite articles.

1. A method implemented by an information handling system that includes a memory and a processor, the method comprising:
identifying a first set of metrics corresponding to a product in response to receiving a first set of product data corresponding to the product;
capturing a second set of product data in response to determining that the first set of product data is deficient based on the first set of metrics;
computing a market value of the product based, at least in part, on the first set of metrics, the first set of product data, and the second set of product data; and
providing the market value to a user.

2. The method of claim 1 further comprising:
receiving feedback from the user in response to providing the market value to the user;
inputting the set of feedback into a machine learning module;
determining, by the machine learning module, a second set of metrics based on the set of feedback; and
collecting a third set of product data based on the second set of metrics.

3. The method of claim 2 further comprising:
removing one or more incorrect assumptions from the first set of product data based on the set of feedback received from the user; and
re-computing the market value in response to removing the one or more incorrect assumptions.

4. The method of claim 2 further comprising:
receiving an initial set of metrics from one or more subject matter experts prior to receiving the first set of product data;
feeding the initial set of metrics into the machine learning module; and
identifying, by the machine learning module, the first set of metrics based on the initial set of metrics.

5. The method of claim 1 further comprising:
querying a set of Internet of Things (IoT) devices in proximity to the product in response to determining that the first set of product data is deficient based on the first set of metrics, wherein the set of IoT devices visually scans a set of areas on the product to collect the second set of product data; and
receiving the second set of product data from the set of IoT devices in response to the querying.

6. The method of claim 1 wherein the second set of product data is a set of visual images, the method further comprising:
performing visual recognition analysis on the first set of product data;
determining a set of weighting values of the first set of metrics based on the visual recognition analysis;
computing the market value based on applying the set of weighting values to the first set of metrics; and
prohibiting a seller of the product from adjusting the computed market value.

7. The method of claim 1 further comprising:
collecting a set of market data corresponding to a set of similar products that are similar to the product;
collecting a set of legal data corresponding to the product; and
computing the market value based on the set of market data and the set of legal data.

8. An information handling system comprising:
one or more processors;
a memory coupled to at least one of the processors;
a set of computer program instructions stored in the memory and executed by at least one of the processors in order to perform actions of:
identifying a first set of metrics corresponding to a product in response to receiving a first set of product data corresponding to the product;
capturing a second set of product data in response to determining that the first set of product data is deficient based on the first set of metrics;
computing a market value of the product based, at least in part, on the first set of metrics, the first set of product data, and the second set of product data; and
providing the market value to a user.

9. The information handling system of claim 8 wherein the processors perform additional actions comprising:
receiving feedback from the user in response to providing the market value to the user;
inputting the set of feedback into a machine learning module;
determining, by the machine learning module, a second set of metrics based on the set of feedback; and
collecting a third set of product data based on the second set of metrics.

10. The information handling system of claim 9 wherein the processors perform additional actions comprising:
removing one or more incorrect assumptions from the first set of product data based on the set of feedback received from the user; and
re-computing the market value in response to removing the one or more incorrect assumptions.

11. The information handling system of claim 9 wherein the processors perform additional actions comprising:
receiving an initial set of metrics from one or more subject matter experts prior to receiving the first set of product data;
feeding the initial set of metrics into the machine learning module; and
identifying, by the machine learning module, the first set of metrics based on the initial set of metrics.

12. The information handling system of claim 8 wherein the processors perform additional actions comprising:
querying a set of Internet of Things (IoT) devices in proximity to the product in response to determining that the first set of product data is deficient based on the first set of metrics, wherein the set of IoT devices visually scans a set of areas on the product to collect the second set of product data; and
receiving the second set of product data from the set of IoT devices in response to the querying.

13. The information handling system of claim 8 wherein the second set of product data is a set of visual images, the processors performing additional actions comprising:
performing visual recognition analysis on the first set of product data;
determining a set of weighting values of the first set of metrics based on the visual recognition analysis;
computing the market value based on applying the set of weighting values to the first set of metrics; and
prohibiting a seller of the product from adjusting the computed market value.

14. The information handling system of claim 8 wherein the processors perform additional actions comprising:
collecting a set of market data corresponding to a set of similar products that are similar to the product;
collecting a set of legal data corresponding to the product; and
computing the market value based on the set of market data and the set of legal data.

15. A computer program product stored in a computer readable storage medium, comprising computer program code that, when executed by an information handling system, causes the information handling system to perform actions comprising:
identifying a first set of metrics corresponding to a product in response to receiving a first set of product data corresponding to the product;
capturing a second set of product data in response to determining that the first set of product data is deficient based on the first set of metrics;
computing a market value of the product based, at least in part, on the first set of metrics, the first set of product data, and the second set of product data; and
providing the market value to a user.

16. The computer program product of claim 15 wherein the information handling system performs further actions comprising:
receiving feedback from the user in response to providing the market value to the user;
inputting the set of feedback into a machine learning module;
determining, by the machine learning module, a second set of metrics based on the set of feedback; and
collecting a third set of product data based on the second set of metrics.

17. The computer program product of claim 16 wherein the information handling system performs further actions comprising:
removing one or more incorrect assumptions from the first set of product data based on the set of feedback received from the user; and
re-computing the market value in response to removing the one or more incorrect assumptions.

18. The computer program product of claim 16 wherein the information handling system performs further actions comprising:
receiving an initial set of metrics from one or more subject matter experts prior to receiving the first set of product data;
feeding the initial set of metrics into the machine learning module; and
identifying, by the machine learning module, the first set of metrics based on the initial set of metrics.

19. The computer program product of claim 15 wherein the information handling system performs further actions comprising:
querying a set of Internet of Things (IoT) devices in proximity to the product in response to determining that the first set of product data is deficient based on the first set of metrics, wherein the set of IoT devices visually scans a set of areas on the product to collect the second set of product data; and
receiving the second set of product data from the set of IoT devices in response to the querying.

20. The computer program product of claim 15 wherein the second set of product data is a set of visual images, the information handling system performing further actions comprising:
performing visual recognition analysis on the first set of product data;
determining a set of weighting values of the first set of metrics based on the visual recognition analysis;
computing the market value based on applying the set of weighting values to the first set of metrics; and
prohibiting a seller of the product from adjusting the computed market value.
